(19) United States
(12) Patent Application Publication
(10) Pub. No.: US 2025/0208042 A1
(43) Pub. Date: Jun. 26, 2025

(54) METHOD AND BORESCOPE FOR IDENTIFYING A SUBSTANCE IN A CAVITY OF AN APPARATUS

(71) Applicant: MTU Aero Engines AG, München (DE)

(72) Inventors: Jude Toscano, Newington, CT (US); Peter Bruce Vannorsdall, Pittsburgh, PA (US)

(73) Assignee: MTU Aero Engines AG, München (DE)

(21) Appl. No.: 18/396,606

(22) Filed: Dec. 26, 2023

(51) Int. Cl. G01N 21/64; G01N 21/85

(52) U.S. Cl. CPC G01N 21/643; G01N 21/6456; G01N 21/8507; G01N 2021/6419; G01N 2021/6439; G01N 2021/6484

(57) ABSTRACT

The invention concerns a method for identifying a substance in a cavity of an apparatus, in particular in a cavity of a turbine engine or turbo machinery, comprising steps of introducing a probe tip of a borescope into the cavity; exposing a substance in the cavity to excitation light by means of the borescope; capturing a fluorescence of the excited substance by means of the borescope; and identifying the substance. The invention further concerns a borescope for identifying a substance in a cavity of an apparatus.

### BACKGROUND OF THE INVENTION

The invention concerns a method for identifying a substance in a cavity of an apparatus, comprising steps of introducing a probe tip of a borescope into a cavity; exposing an unknown substance in the cavity to an excitation light by means of the borescope; capturing a fluorescence of the excited substance by means of the borescope; and identifying the substance. The invention further concerns a borescope for identifying a substance in a cavity of an apparatus. The invention further concerns a borescope for marking flaws, e.g., marking with paint, in a cavity of an apparatus to expedite identification of flaws post-disassembly.

A variety of non-destructive testing methods are used during manufacturing and maintenance of safety critical components of machinery, in particular turbo engines. For visual inspection, where the target area is inaccessible by other means, or where accessibility may require destructive, time consuming and/or expensive dismounting activities borescopes may be utilized to identify defects or imperfections. Such borescopes may comprise the means for performing a fluorescent penetrant inspection (FPI), which is a type of dye inspection in which a fluorescent dye is applied to a surface of a material in order to detect defects that may compromise the integrity or quality of the part in question.

Current methods and borescopes with integrated FPI capabilities do not allow an operator to differentiate between different substances in target areas where accessibility is difficult or limited. Furthermore, current methods and borescopes do not allow an operator to mark an identified flaw in-situ as a means of expediting rediscovery of the flaw post-disassembly of the engine or engine module. In particular, current methods and borescopes do not allow an operator to mark a flaw with high temperature-resistant paint that can withstand high-temperature environments, such as the standard operating conditions of a turbine engine. Note that turbine engines are frequently used after initial flaws are detected but before engine disassembly.

### SUMMARY OF THE INVENTION

In light of the above, it is an objective of the present invention to propose an improved method for the inspection of an apparatus, such as a turbine engine or other turbo machinery. In particular, it is an objective of the present invention to introduce an improved method for identifying a substance in a cavity of an apparatus. Furthermore, it is an objective of the present invention to introduce an improved method for marking flaws in a cavity of an apparatus. It is also an objective of the present invention to mark a flaw observed on a component within an apparatus. This is achieved according to the invention through the teaching of the independent claims. Advantageous embodiments of the invention are the subject of the dependent claims.

In order to solve the above problems, methods for identifying a substance and marking flaws in a cavity of an apparatus, marking flaws on a component in an apparatus, and in particular in a cavity of a turbine engine or other turbo machinery, is proposed. Comprising steps of identifying a substance include introducing a probe tip of a borescope into a cavity of the apparatus; exposing a substance in the cavity to excitation light of various wavelengths, in particular UV light, by means of the borescope; capturing a fluorescence of the excited substance by means of the borescope; and identifying the substance based on known fluorescent signatures. Comprising steps of marking flaws include introducing a probe tip of a borescope into a cavity of the apparatus; using pressurized air to extract a marking fluid from its reservoir and to spray the marking fluid, such as thermal paint, on or near a detected flaw; once dried, the marking fluid will act as a visual indicator to improve the ability of subsequent inspectors to quickly identify the flaw.

By the proposed method an unknown substance may be excited via UV light, in order to prompt the unknown substance to fluoresce. This fluorescence of the unknown substance may be collected and compared to a database of fluorescent signatures of known substances, as a means of identification. These known fluorescent signatures may be held in a database and the process of identification or comparison may be performed digitally without having to remove the probe from the apparatus. Hence, the identification process for an unknown substance especially a substance located at a difficult-to-reach location of an apparatus, and/or a machine may be improved. The unknown substance may be a fluid, as for example a lubricant, fuel, preservation fluid or hydraulic fluid. Also, the unknown substance may be an substance like a residue or deposit formed during different operating conditions of the apparatus as for example an engine buildup or sulfidation/oxidation of components.

Furthermore, by the proposed method, a flaw detected during standard borescope operations can be marked to expedite flaw identification during subsequent inspections. Specifically, after a flaw is detected by an operator, the operator can release a burst of pressurized air through the capillary tube that runs the length of the borescope, exiting through the borescope tip. The exiting air creates a region of low pressure at the probe tip, which is used to draw marking fluid, e.g., paint, from a reservoir attached to the probe tip. As the marking fluid is drawn from the probe tip, it becomes atomized, resulting in a spray of marking fluid. The spray of marking fluid is used to tag flaws or areas of interest for subsequent inspections.

According to a further aspect of the proposed invention, the borescope assembly is comprised of five primary components: a probe tip, an external evaluation unit, an external compressed air supply, and external power supply for excitation light, and a borescope snake/or insertion tube. The probe tip is comprised of a camera, an excitation light emitting device, such as a UV led or fiber optics for transmitting UV light, a fluorescence capturing device, and a mounted reservoir for marking fluid. The external evaluation unit is comprised of a spectrometer for analyzing the collected fluorescence; the spectrometer is connected to the probe tip via fiber optics. The external compressed air supply is connected to the probe tip via capillary tubing. The external power supply for excitation light can take two forms. For designs with an LED mounted on the probe tip, the external power supply is used to power the LED. For designs where excitation light is emitted from the probe tip via fiber optics, an externally mounted fiber-coupled LED is powered by the external power supply. The final component, the borescope snake/or insertion tube, is a flexible or rigid tube arrangement that houses the fiber optics, capillary tubes, and electrical wiring connected between external components and the probe tip. The borescope may in some embodiments be designed to execute the steps of the method herein described.

The probe tip is introduced and/or placed in a cavity in order to inspect the state of the cavity. A cavity within the sense of the present invention comprises an area or region of an apparatus, machine component and/or machine, which is not or at least not easily accessible with conventional inspection means especially due to size constraints or the built-in situation. Such apparatuses or regions of an apparatus or a component are typically investigated by means of a borescope, which is an optical instrument designed to be entered into such cavities and to assist visual inspection of narrow, difficult-to-reach areas.

In some embodiments the method further comprises the step of detecting a substance in the cavity by means of a camera that is integrated into the probe tip of the borescope. The excitation light or UV light emitting device, which may for example be implemented as a UV LED i.e. UV light source, may be designed and used to illuminate the cavity, in order to detect a substance within the cavity by means of the integrated camera. In some embodiments the evaluation unit comprises a display. The display may be equipped to display imaging and/or a video feed captured by means of the integrated camera of the borescope probe tip. In some instances, fluorescence may be intense enough to be visible on the display without the need of additional sensors. The display can also show the spectral signature of the fluorescence and the substance identification results, as determined by the external evaluation unit. This may aid an operator of the borescope to detect and identify a substance within a cavity.

In particular upon detection, the excitation light emitting device is employed to excite the unknown substance in order to activate fluorescence of the substance. When an unknown substance is detected, excitation light emitted from an emitting device integrated in the probe tip can excite the unknown fluid, often causing it to fluoresce. In some embodiments, the excitation light is ultraviolet, typically with wavelengths ranging from 200 nm to 400 nm. For example, UV light sources are frequently used to get hydrocarbon-based substances, such as lubricating oil, to fluoresce. Therefore, the borescope may include at least one UV light source capable of emitting a broad or narrow spectrum of UV light. While UV is the most common excitation light, other wavelengths, such as infrared, are also used, i.e. wavelengths ranging from 400-750 nm (visible), or 750-1600 nm (infrared). Therefore, the borescope may also include a light source capable of emitting other non-UV wavelengths.

In some embodiments, the LED integrated in the probe tip is replaced by one or multiple fiber optics. In this configuration, one end of the fiber or bundle of fibers is coupled to an LED that is housed externally, while the other end is integrated in the probe tip. Bifurcated fiber bundles may also be employed, in which case the bifurcated ends may connect to multiple external LEDs, while the common end is integrated in the probe tip. To increase mechanical flexibility, a plurality of small (approx. 5 μm diameter) optic fibers, may be used. Connecting an external light source to the probe tip via fiber optics may help circumvent possible size restrictions that could arise from integrating an LED in the probe tip.

Once the substance fluoresces, the capturing device, which is designed for capturing the fluorescence emitted by an excited substance in a cavity, transmits the captured fluorescence via fiber optics to the evaluation unit which measures the spectral distribution of the fluorescence in question. The capturing device may comprise or be ends of the first fiber optical arrangement and may further comprise an optical element capable of enhancing the capturing process.

The first fiber optical arrangement is designed to transfer fluorescence i.e. a fluorescent signal from the probe tip i.e. the capturing device located at the probe tip, to the remotely located spectrometer assembly or spectrometer, which may be used to create a plot of the corresponding fluorescent signature. The fiber optical arrangement may comprise one or more fiber(s) and/or a bifurcated fiber bundle and may for example be implemented as a single, relatively large (approx. 1000 μm diameter) optic fiber to transfer fluorescence from the probe tip to the spectrometer. In other embodiments hundreds of relatively small (approx. 5 μm diameter) optic fibers may be used, to transfer fluorescence from the probe tip to the spectrometer, wherein the individual optic fibers may merge to a common end before connecting to the spectrometer assembly.

The proposed borescope may employ the integrated spectrometer assembly and/or spectrometer to identify and/or differentiate between different fluorescing substances. The spectrometer assembly may comprise a long pass filter and/or a spectrometer. The long pass filter may be positioned upstream of the spectrometer and is intended and/or arranged to prevent any of the original excitation UV light from entering into the spectrometer. The spectrometer may comprise a high spectral resolution sensor and is equipped to measure the spectral signature of the fluorescence or fluorescent light received, which in some embodiments may earlier have passed through the long pass filter. The spectrometer outputs the spectral signature based on the collected fluorescence. This fluorescent signature may then, in particular by means of the spectrometer or the processing device, be compared to a collection of known fluorescent signatures, which may be stored in a database, to identify the substance. In particular analytical methods may be used to identify the substance and/or classify the type of substances comprising the detected fluorescence signal i.e. captured fluorescent signal. The database of known fluorescent signatures will consist of “neat” signatures, i.e., signatures corresponding to individual substances, as well as blended signatures, i.e., signatures corresponding to mixtures of multiple substances. The database will also contain signatures of substances throughout their lifecycle, e.g., fresh turbine oil and heavily degraded turbine oil.

The database preferably comprises fluorescent signatures of the most common substances found in, but not limited to, aviation, automotive, and marine applications. Specific substances of aviation applications, for instance, include different types of lubricants, fuels, preservation fluids, hydraulic fluids and substances resulting from operation conditions of the apparatus or engine as for example engine buildups or sulfidation/oxidation substances. Furthermore, the database may also comprise fluorescent signatures for a given substance or fluid at one or more stages throughout its lifecycle. For example, a fluorescent signature of oil may change as it degrades. Therefore, fluorescent signatures for fresh oil, oil after 100 flights, oil after 200 flights, etc. may be used as reference fluorescent signatures for identifying the substance.

In some embodiments the method further comprises steps of dispensing a reactant to the substance by means of the borescope and capturing a reaction of the substance by means of the devices integrated into the borescope probe tip. Therefore, in some embodiments the borescope may comprise a tube device, wherein the tube device may comprise an in particular capillary tube capable of transferring a reactant such as a reactant fluid and/or a reactant powder, e.g. a solvent, a penetrant and/or a developer agent into the cavity and/or to the substance. Such tube device may be integrated within the borescope and/or the probe tip, wherein a hose may be at least partially arranged in the tube arrangement and may be designed to transfer the reactant from a reservoir to the probe tip and such into the cavity and/or to the substance to be identified. Pressurized air may be used to transfer the reactant from an external or remote reservoir, through the capillary tube, and out the probe tip of the borescope.

Some fluids especially within an engine or machine do not fluoresce. Therefore, the ability to identify such fluid may be enhanced by introducing a new agent i.e. reactant via the tube device, especially one that is known to react with certain suspected fluids. Such reactant, when mixed with the fluid to be identified, will react in a manner that may aid an operator. For example, the addition of the reactant may help an operator visually identify the fluid using the integrated camera. Furthermore, the tube device may be employed to enhance detection capabilities by introducing a reactant that reacts with substances as for example sulfidation and/or oxidation but not with standard engine buildup caused by engine operation. A reactant that reacts with sulfidation/oxidation but not with normal engine buildup may therefore be dispensed as a means of substance classification. By means of one or more remotely located reservoir(s) a wide selection of reactants may be provided in order to enable identifying non-fluorescing fluids and/or substances especially such fluids and/or substances most commonly found in engines and/or machines.

In some embodiments the method further comprises steps of dispensing a paint especially a thermal paint by means of the borescope and/or its tube device. The tube device may comprise a retractable felt tip, which is designed to be attached to the probe tip of the borescope. The paint may be used to mark a component or part of the apparatus and/or cavity. A part or component marked using this method may easily be identified for future borescope inspections and/or for in-depth measurements and analysis after the apparatus is disassembled. The advantage of using thermal paint is that it will adhere to the part and remain visible for a longer period of time, as it may be capable of withstanding several operating cycles of the apparatus without fading. For example, the paint will remain easily detectable after several flights for aviation apparatuses.

In some embodiments the borescope may comprise a dispensing device, which may be designed for single or limited number of uses, that may be attachable to the probe tip. In some embodiments the dispensing device may comprise a nozzle module, which may act as a nebulizer and be arranged to atomize and/or disperse a desired reactant and/or paint. The nozzle may be arranged perpendicularly to an outlet of the capillary tube device. Air flowing through the capillary tube creates a region of low pressure at the tip of the probe, which subsequently draws paint from the attached paint reservoir through the nozzle. As the paint is drawn from the reservoir and mixes with the flow of air exiting the capillary tube, it becomes atomized, forming a spray. By optimizing the viscosity of the reactant and/or paint, the reactant and/or paint within the module will only be drawn out when the air is flowing through the capillary tube device, allowing an operator to precisely control when the reactant and/or paint is sprayed or dispensed within the cavity. Extracting the reactant and/or paint from a nozzle at the tip of the probe rather than passing the reactant and/or paint through the entire length of the capillary tube may help prevent build up and partial blockages within the capillary tube device. Furthermore, a purging process of the tube device when switching between reactants may be rendered redundant.

Further features, advantages and possible applications of the invention will result from the following description in connection with the figures. In general, features of the various exemplary aspects and/or embodiments described herein, in particular of the apparatus and method, may be combined with each other unless clearly excluded in the context of the disclosure.

In the following part of the description, reference is made to the figures shown to illustrate specific aspects and embodiments of the present invention. It is understood that other aspects may be used and structural or logical changes may be made to the illustrated embodiments without departing from the scope of the present invention. The following description of the figures is therefore not to be understood as limiting.

### BRIEF DESCRIPTION OF THE DRAWINGS

FIG. 1 shows a first schematic representation of an exemplary borescope for identifying a substance in a cavity of an apparatus according to the invention.

FIG. 2 shows a second schematic representation of an exemplary borescope for identifying a substance in a cavity of an apparatus according to the invention.

FIGS. 3a to 3c show schematic representations of exemplary probe tips of borescopes for identifying a substance in a cavity of an apparatus according to the invention.

FIG. 4 shows a flow chart of an exemplary method for identifying a substance in a cavity of an apparatus according to the present invention.

### DESCRIPTION OF THE INVENTION

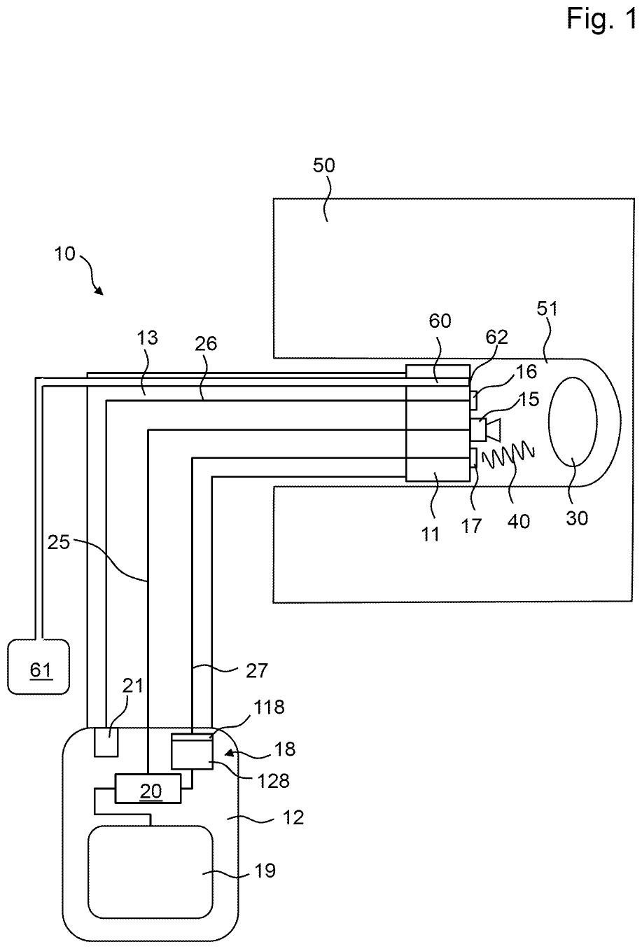

FIG. 1 depicts a first schematic representation of an exemplary borescope 10 for identifying a substance 30 in a cavity 51 of an apparatus 50 according to the invention.

The borescope 10 comprises a probe tip 11 and an evaluation unit 12, wherein the probe tip 11 and the evaluation unit 12 are connected via a flexible or rigid tube arrangement 13. The probe tip 11 is designed to be introduced into a cavity 50 and comprises a camera 15, an excitation light emitting device 16 and a capturing device 17. The evaluation unit 12 comprises a spectrometer assembly 18, a display device 19 and a processing unit 20.

The camera 15 may be connected to the processing unit 20 via at least one signaling line 25 and visual imagery captured by the camera 15 may be displayed to a operator by means of the display device 19. Hence, the camera 15 may be used to detect a substance 30 in the cavity 51.

The excitation light emitting device 16 of the depicted embodiment is connected to a remote excitation light source 21 located in the evaluation unit 12 via a second fiber optical arrangement 26. The second fiber optical arrangement 26 being designed to transfer excitation light to the light emitting device 16, which may emit said excitation light in order to expose the substance to the UV light and excite fluorescence 40 from the substance 30. The excitation light may comprise but is not limited to, a wavelength from 200 nm to 400 nm.

The capturing device 17 is arranged to capture the fluorescence 40 of the substance 30. The capturing device 17 is connected to the spectrometer assembly 18 by means of a first fiber optical arrangement 27 in order to transfer the captured fluorescence 40 to the spectrometer assembly 18 for evaluation. The spectrometer assembly 18 comprises a long pass filter 118 and a spectrometer 128. The long pass filter 118 is arranged to prevent any of the original excitation light from entering into the spectrometer 128. For example, if the excitation LED 21 has a central wavelength of 340 nm and a full width at half maximum of 30 nm, the long pass filter with a cutoff wavelength of 400 nm may be used to ensure that the excitation light will not reach the spectrometer 128. All light at wavelengths above 400 nm will pass through the long pass filter 118 and enter the spectrometer 128.

The spectrometer 128 is arranged to measure a spectral signature of the fluorescence 40 or fluorescent light received and/or to create a fluorescent signature. This fluorescent signature may be compared to a collection of known fluorescent signatures to identify the substance 30. This identifying process may be performed by the processing unit 20, which may also comprise a database comprising said known fluorescent signatures.

The borescope 10 further comprises a tube device 60 with an outlet 62 at the probe tip 11. The tube device 60 may comprise a capillary tube capable of transferring a reactant for a remote reservoir 61 to the substance 30 and/or into the cavity 51.

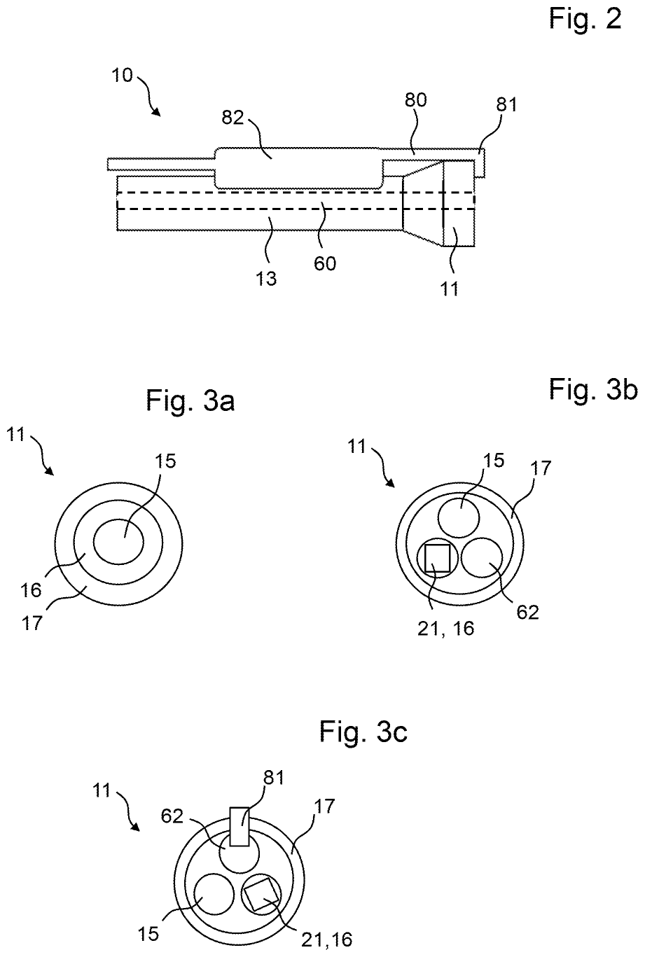

FIG. 2 depicts a second schematic representation in part of the exemplary borescope 10 for identifying a substance 30 in a cavity 51 of a apparatus 50 according to the invention of FIG. 1. In order to be more comprehensible, the depiction of the probe tip 11 is simplified.

The borescope of the depiction comprises a dispensing device 80, which is designed for single or limited use device and is attachable to the probe tip 11 of the borescope 10. The dispensing device 80 comprises a nozzle module 81, which is arranged perpendicularly to an outlet 62 of the tube device 60. The dispensing device 80 further comprises a repository 82. A reactant and/or paint may be sucked through the nozzle 81 be means of an air current, which may be provided by the tube device 60 situated in the borescope 10.

FIGS. 3a to 3c depict three schematic front view representations of exemplary probe tips 11 of borescopes 10 for identifying a substance 30 in a cavity 51 of an apparatus 50 according to the invention. FIG. 3a shows a first embodiment in which a camera 15, an excitation light emitting device 16 and a capturing device 17 are arranged concentrically on the probe tip 11. In particular the use of a first and a second fiber optical arrangement 26, 27 may allow for such layouts, as a multitude of fibers of the fiber optical arrangements 26, 27 may be arranged in concentrical circles around a centrally positioned camera 15. The concentrical succession may be altered in other embodiments. By means of such layout, a space-saving arrangement for the probe tip modules 15, 16, 17 may be provided.

FIG. 3b shows a second embodiment in which a camera 15, an excitation light emitting device 16 and a tube device 60 i.e. its outlet 62 are arranged evenly distributed on a surface the probe tip 11. A capturing device 17 comprising a first fiber optical arrangement 27 is arranged at a periphery of the probe tip 11. The excitation light emitting device 16 is implemented as a UV light source 21 directly mounted to the probe tip 11.

FIG. 3c shows a third embodiment in which a camera 15, a UV light emitting device 16 and a tube device 60 i.e. its outlet 62 are arranged evenly distributed on a surface the probe tip 11. A capturing device 17 comprising a first fiber optical arrangement 27 is arranged at a periphery of the probe tip 11. The excitation light emitting device 16 comprises a second fiber optical arrangement 26, which is arranged to transmit a UV light from a remote UV light source 21. A nozzle device 81 of a dispensing device 80 is arranged to overlap with the outlet 62 of the tube device 60 in order to transport a reactant and/or paint to a substance 30 and/or into a cavity 51 of an apparatus 50.

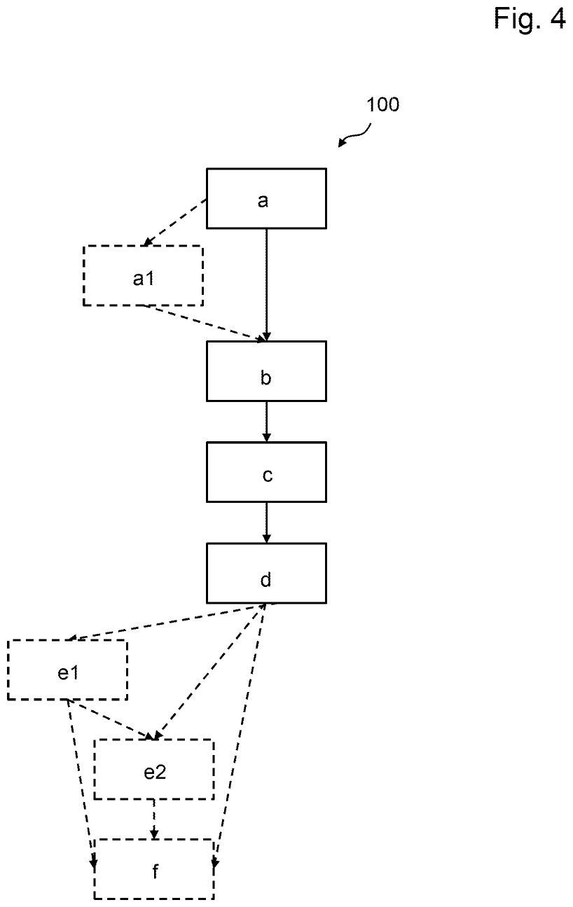

FIG. 4 depicts a flow chart of an exemplary method 100 for identifying a substance 30 in a cavity 51 of an apparatus 50 according to the present invention.

In a first step a) a probe tip 11 of a borescope 10 is introduced into a cavity 51 of a apparatus 50. In an optional step a1) a camera 15 of the borescope may be used to detect and/or locate a substance 30 within the cavity 51. In a step b) the substance 30 is exposed to excitation light by means of the borescope, in particular by means of an excitation light emitting device 16 arranged on a probe tip 11 of the borescope 10, hence exciting the substance 30 to fluoresce.

In a subsequent step c) the fluorescence 40 of the excited substance 30 is captured or collected by means of the borescope 10. A capturing device 17 arranged on the probe tip 11 of the borescope may comprise a first fiber optical arrangement 27 in order to transmit the fluorescence 40 to a spectrometer assembly 18. In a step d) of the method the substance 30 is identified based on known fluorescent signatures, in particular by means of a processing unit 20 of the borescope 10.

In an optional step e1) a reactant may be dispensed to the substance 30 by means of the borescope 10, in particular a tube device 60 and/or a dispensing device 80 of the borescope 10. In a further optional step e2) a reaction of the substance 30 may be captured by means of the borescope 10, in particular a camera 15 of the borescope 10 and displayed on a display device 19 of the borescope 10, in order for an operator to identify the substance 30 based on its reaction with the reactant.

In a further optional step f) a paint may be dispensed by means of the borescope 10, in particular by a dispensing device 80 or a felt tip attached to the probe tip 11 of the borescope 10 in order to mark an area for future inspection.

What is claimed is:

1. A method for identifying a substance in a cavity of an apparatus, comprising the following steps:
a) introducing a probe tip of a borescope into a cavity of the apparatus;
b) exposing a substance in the cavity to excitation light by means of the borescope;
c) capturing a fluorescence of the excited substance by means of the borescope; and
d) identifying the substance based on known fluorescent signatures.

2. The method according to claim 1, further comprising the steps of:
e1) dispensing a reactant to the substance by the borescope; and
e2) capturing a reaction of the substance by means of the borescope.

3. The method according to claim 1, further comprising the step of:
f) dispensing a paint by means of the borescope.

4. The method according to claim 1, further comprising the step of:
a1) detecting a substance in the cavity by means of a camera of the borescope.

5. The method according to claim 1, wherein the excitation light comprises a wavelength or range of wavelengths from 200-400 nm (ultraviolet), 400-750 nm (visible), or 750-1600 nm (infrared).

6. A borescope for identifying a substance in a cavity of an apparatus, comprising:
a probe tip and an evaluation unit, the probe tip comprising a camera, an excitation light emitting device and a capturing device for capturing a fluorescence, the evaluation unit comprising a spectrometer assembly, wherein the capturing device is connected to the spectrometer assembly by a first fiber optical arrangement.

7. The borescope according to claim 6, wherein the excitation light emitting device comprises a second fiber optical arrangement for transferring and emitting a excitation light from a remote excitation light source.

8. The borescope according to claim 6, wherein the evaluation unit comprises a display device.

9. The borescope according to claim 6, further comprising a tube device.

10. The borescope according to claim 9, further comprising a dispensing device.

11. The borescope according to claim 6, wherein the camera, the excitation light emitting device and the capturing device are arranged concentrically on the probe tip.

12. The method of claim 1, wherein the cavity of an apparatus is a cavity of a turbine engine or turbo machinery.

13. The borescope of claim 6, wherein the cavity of an apparatus is a cavity of a turbine engine or turbo machinery.
